(19) United States
(12) Patent Application Publication
(10) Pub. No.: US 2002/0084629 A1
(43) Pub. Date: Jul. 4, 2002

(54) Utility cart

(76) Inventors: Jordan Levy, Worcester, MA (US); Noah B. Caney, Westford, MA (US)

Correspondence Address: IANDIORIO & TESKA, 260 BEAR HILL ROAD, WALTHAM, MA, 02451-1018, US

(21) Appl. No.: 09/754,901

(22) Filed: Jan. 4, 2001

(51) Int. Cl. B62B 1/00

(52) U.S. Cl. 280/651; 280/47.18

(57) ABSTRACT

A utility cart including a frame with an upper end and a lower end, a handle extending upwardly from the upper end of the frame, at least a pair of wheels attached to the lower end of the frame, a platform extending outwardly from the lower end of the frame; and an angled support bar extending from a position proximate the lower end of the frame and terminating at a position spaced from the upper end of the frame out over the platform.

### FIELD OF THE INVENTION

This invention relates to a utility cart for shopping, gardening, and other types of activities.

### BACKGROUND OF THE INVENTION

Utility carts, hand trucks, bag caddies, tool caddies, and bag dollies are well known in the art. To our knowledge, however, no one has combined in one device features which allow the consumer to both cart around items in a removable utility bag and to also transport larger items such as boxes. Furthermore, no devices to our knowledge allow the user to bring gardening tools to the garden and also to transport leaf or garbage bags and also larger items such as large sacks of fertilizer and the like.

### SUMMARY OF THE INVENTION

It is therefore an object of this invention to provide a more universal utility cart.

It is a further object of this invention to provide such a utility cart which combines the features of a hand truck, a bag caddy, and a utility bag in a single cart.

It is a further object of another embodiment of this invention to provide such a utility cart which combines the features of a tool caddy, a hand truck and a bag dolly in a single utility cart.

It is a further object of this invention to provide two different embodiments of a utility cart utilizing the same primary components to reduce manufacturing costs.

It is a further object of this invention to provide utility carts which are simple and yet aesthetically pleasing in design and inexpensive to manufacture.

It is a further object of this invention to provide such a utility cart which allows the consumer to both cart around items in a utility bag, to remove the utility bag for separate use, and to transport larger items such as boxes.

It is a further object of this invention to provide such a utility cart which allows the user to bring gardening tools to the garden and also to transport leaf or garbage bags and also larger items such as large sacks of fertilizer and the like.

The invention results from the realization that by angling the support bar of a utility cart to extend from the lower end of the cart upwards out over the support platform, a more aesthetically appealing utility cart can be manufactured which is easier to use and which can be readily manufactured in at least two versions: a combined hand truck, bag caddy, and removable utility bag type cart and a combined tool caddy, hand truck, and bag dolly type cart.

This invention features a utility cart comprising a frame with an upper end and a lower end, a handle extending upwardly from the upper end of the frame, at least a pair of wheels attached to the lower end of the frame, a platform extending outwardly from the lower end of the frame, and an angled support bar extending from a position proximate the lower end of the frame and terminating at a position spaced from the upper end of the frame out over the platform.

The frame typically includes a pair of spaced vertical supports and a plurality of spaced horizontal supports extending between the pair of spaced vertical supports. The handle is usually in the shape of a U-shaped bar and may be collapsible downward into the frame.

The platform is also typically in the shape of a U-shaped bar and may include a foot member. The platform is typically hinged to the frame and foldable to a position adjacent the frame. A mechanism may be included for locking the platform in an unfolded position extending outwardly from the lower end of the frame and may also include a mechanism for locking the platform in a folded position.

The angled support bar is typically U-shaped and includes two spaced side members and a front member interconnecting the terminal ends of the two spaced side members. The frame then includes a stop member for one or both side members forming an angle of between 0° and 47° between the side members and the frame. The proximal ends of the two spaced side members are typically hinged to the frame to allow the support bar to be folded up against the frame. The frame typically includes at least one locking mechanism for retaining the support bar in a position folded against the frame. The frame may comprise tubular members encased in a plastic housing and at least one tray attached to a rearward portion of the frame. A handle tray may be included with at least one forward implement holder. Also included are a bridge tray with at least one implement holder and a bottom tray with a plurality of compartments.

In one embodiment, a foldable bag is supplied which rests on the platform and retained in an open configuration by the angled support bar. The foldable bag may include eyelets and the frame member then includes hooks which extend through the eyelets to releasably secure the bag with respect to the frame. The foldable bag may also include a securable flap which overlaps the support bar.

The combined utility bag, hand truck, and bag caddy embodiment of the utility cart of this invention includes a frame with upper and lower ends, a handle extending from the upper end of the frame, a platform extending outwardly from the lower end of the frame, a support bar extending from the frame out over the platform, and a bag supported on the bottom thereof by the platform and retained in an open configuration by the support bar.

The combined tool caddy, hand truck, and bag dolly embodiment of the utility cart of this invention includes a frame with an upper end and a lower end, a handle extending from the upper end of the frame, a platform extending outwardly from the lower end of the frame, a support bar extending from the frame out over the platform for supporting a bag, and at least one tool tray attached to the frame.

In all embodiments, the utility cart typically includes a frame with upper and lower ends, a handle extending upwardly from the upper end of the frame, a platform extending outwardly from the lower end of the frame, an angled support bar including side members extending from a position proximate the lower end of the frame and a front member spaced from the upper end of the frame out over the platform. The frame typically includes at least one stop member for a said side member the support bar forms an angle of between 0° and 47° between the side members of the support bar and the frame. Also included may be a locking mechanism for retaining the support bar in a position folded against the frame.

### BRIEF DESCRIPTION OF THE DRAWINGS

Other objects, features and advantages will occur to those skilled in the art from the following description of a preferred embodiment and the accompanying drawings, in which:

FIG. 1 is a schematic three dimensional view of one embodiment of the utility cart of the subject invention;

FIG. 2 is a front view of the utility cart shown in FIG. 1;

FIG. 3 is a view of the utility bag portion of the utility cart shown in FIG. 1;

FIG. 4 is a schematic view of the utility cart shown in FIG. 1 in the hand truck configuration;

FIG. 5 is a partial exploded view of the embodiment of the utility cart shown in FIG. 1;

FIG. 6 is a three dimensional schematic view of another embodiment of the utility cart of the subject invention;

FIG. 7 is a three dimensional schematic view of the utility cart shown in FIG. 6 filled with gardening tools and supplies in accordance with the subject invention;

FIG. 8 is a front view of the utility cart shown in FIG. 6 in the hand truck configuration;

FIG. 9 is another view of the utility truck of FIG. 6 used in connection with a leaf collection bag;

FIG. 10 is a schematic view of the support platform blocking mechanism and the removable bottom tool tray of the utility cart of the subject invention; and

FIGS. 11-13 are schematic views of the utility cart shown in FIG. 6 depicting how implements such as rakes and brooms are held in place but angled in two directions away from the user in accordance with the subject invention.

### DISCLOSURE OF THE PREFERRED EMBODIMENTS

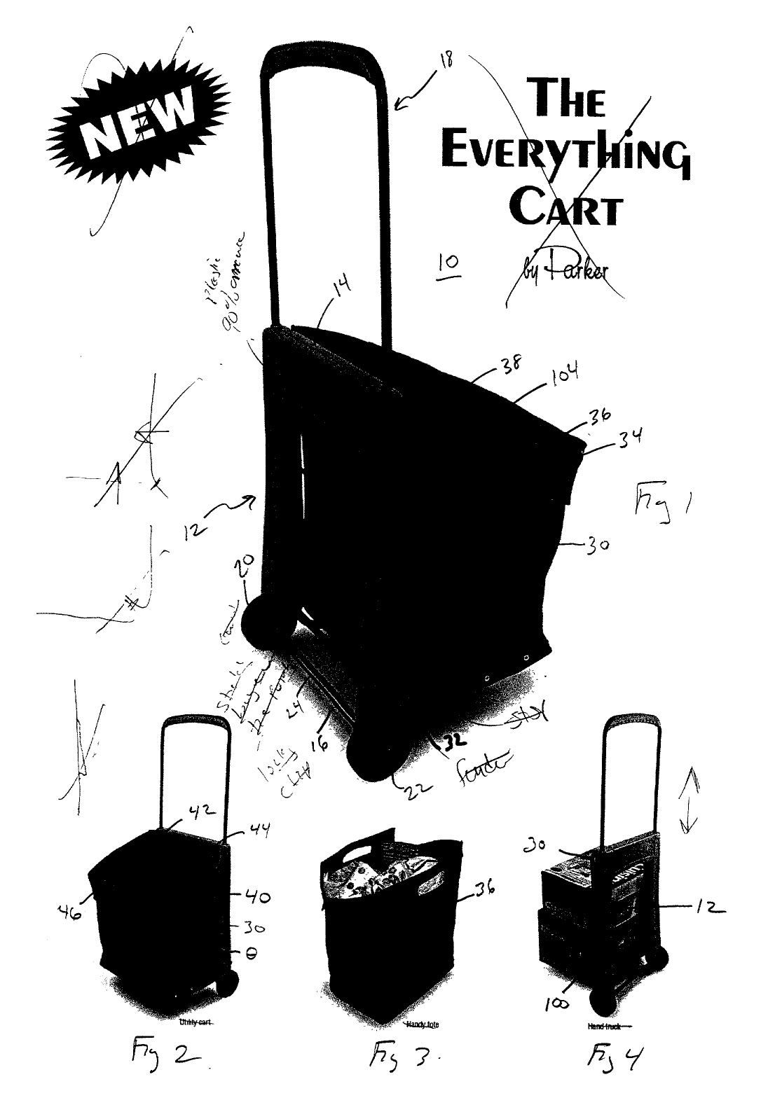

Utility cart 10, FIG. 1 includes frame 12 with upper end 14 and lower end 16. Handle 18 extends upwardly from upper end 14 of frame 12 and may be collapsible downwardly within frame 12 as is known by those skilled in the art.

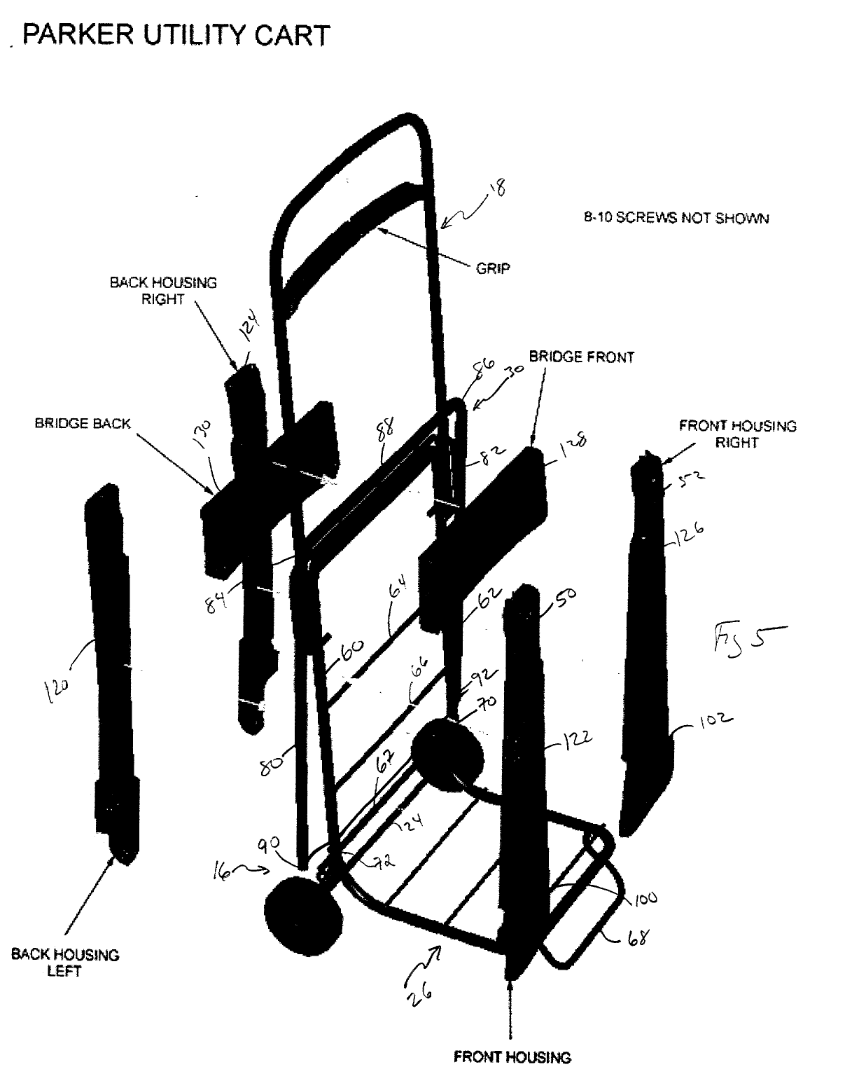

Wheels 20 and 22 reside on axle 24 fixed at and spanning the lower end 16 of frame 12. Platform 26, FIG. 2 extends outwardly from the lower end 16 of frame 12.

Angled support bar 30, FIG. 1 extends from a position 32 proximate the lower end 16 of frame 12 and terminates at an open position 34 spaced from the upper end 14 out over the platform as shown in FIG. 1. This configuration uniquely provides a downwardly slanted opening 38 in utility bag 36 which makes it easier to fold up against frame 12 and easier to fill with items especially by elderly individuals who use cart 10 for shopping purposes.

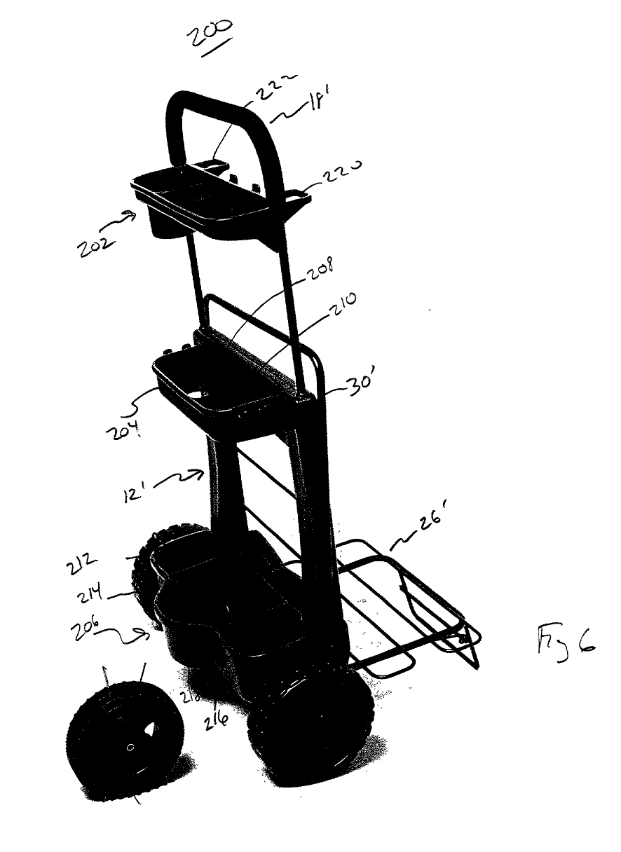

Utility cart 10 is thus useful as a bag caddy 48 as shown in FIGS. 1 and 2 and as a hand truck as shown in FIG. 4 when angled support bar 30 is folded up against frame 12 with or without utility bag 36, FIG. 3 in place.

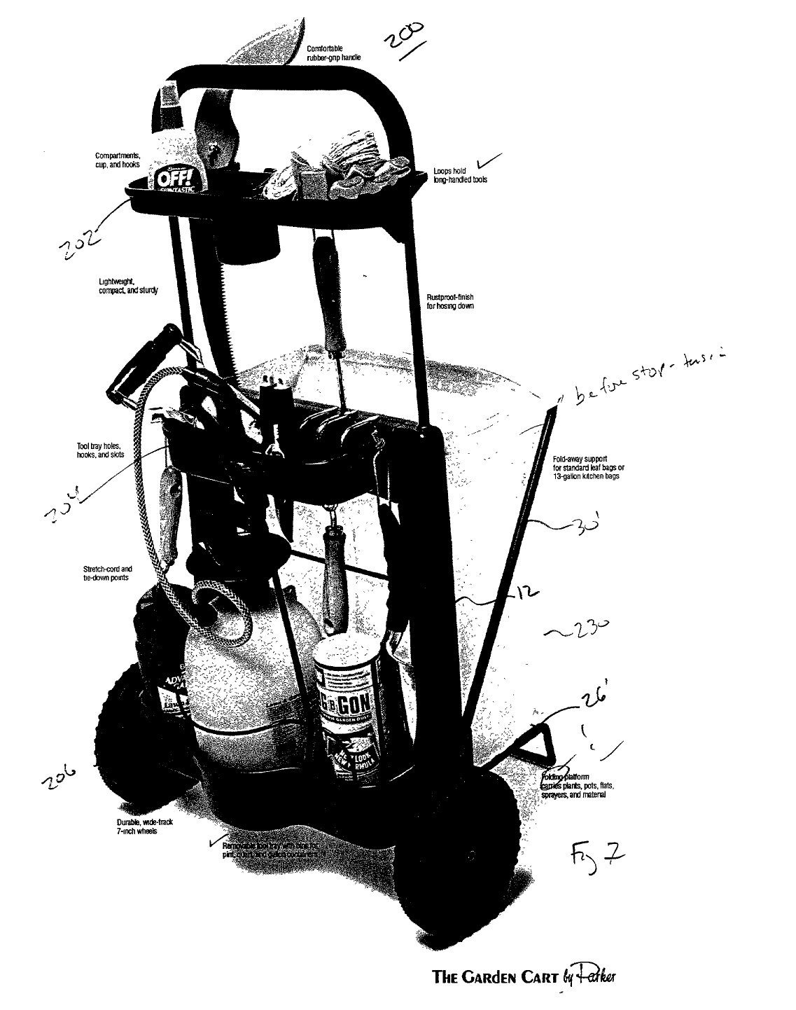

In the case where utility bag 36 is removed from frame 12 and support bar 30 as shown in FIG. 3 it can be hand carried around a store. To that end, utility bag 36, FIG. 2 includes a rigidized bottom and is foldable along seam 40. Utility bag 36 also includes eyelets 42 and 44 and flap 46 which overlaps support bar 30 and secured in that position by a releasable fastener (not shown) such as a hook and loop (Velcro™) strips. Frame 12, FIG. 5, in turn includes hooks 50 and 52 which receive reinforced eyelets 42 and 44, FIG. 2. Frame 12, FIG. 5, in the preferred embodiment, includes space tubular vertical supports 60, 62 and horizontal supports 64, 66, and 67 extending therebetween for structural rigidity and to allow stretch cords, for example, to be used in the hand truck configuration show in FIG. 4. Handle 18 and platform 26 are typically formed of U-shaped tubular members as shown in FIG. 5. Platform 26 preferably includes foot member 68 for stability. Platform 26 is hinged to frame 12 at horizontal support 67 as shown at 70 and 72.

Angled support bar 30 is also U-shaped and includes spaced side members 80, 82 interconnected on their terminal ends 84, 86 by front member 88. The proximal ends 90 and 92 of side members 80, 82 in turn, are hinged to the frame as shown at 32 in FIG. 1 to allow the support bar to be folded against frame 12 as shown in FIG. 4. Frame 12 includes angled stop members 100 and 102, FIGS. 4-5, which stop angled support bar 30 in an open position such that an angle θ of between 0° and 47° is formed between side members 80 and 82 and the plane defined by frame 12 as shown in FIG. 2. Frame 12 also includes locking mechanisms such as spring clip 104, FIG. 1 (typically one such clip on each vertical support) for retaining bar 30 in a folded position adjacent frame 12 as shown in FIG. 4.

The stops on the frame covers allow the support to open from closed position (0°) to a maximum of 47°. Use of kitchen garbage bag limits the travel of the support to less than 47°. When support bar is used with a standard kitchen trash bag, support bar keeps bag open by gravity on support bar and the bar does not reach stops on frame. In paper leaf-bag mode, the bar rests on stops at full 47° open, creating the perfect opening/framework for holding the standard size bag.

In the preferred embodiment, many of the tubular members of the frame are encased in plastic housing pieces as shown in FIG. 5, for example, left side back and front housing pieces 120, 122; right side back and front housing pieces 124, 126; and front and rear bridge pieces 128, 130.

In another embodiment, which includes many of the same components described above, combined tool caddy, hand truck, and bag dolly utility cart 200, FIG. 6 includes a number of tool and equipment trays attached to the frame. Frame 12′, handle 18′, support platform 26′, and angled support bar 30′ are similar to the embodiment shown in FIGS. 1-5.

The rear side of frame 12′, however, now includes bridge tray 204 with implement holder orifices 208 and 210, bottom tray 206 with compartments 212, 214, and 216, and rack 218. Handle 18′, in turn, includes handle tray 202 with forward implement holders 220 and 222.

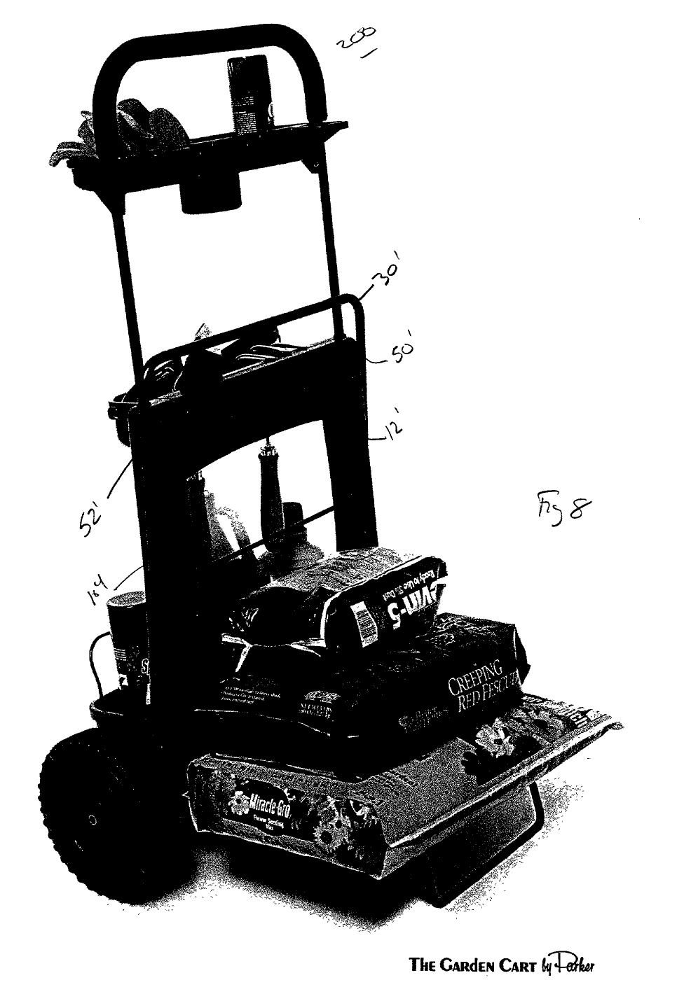

The usefulness of these features is depicted in FIG. 7 where many gardening tools and supplies can be carried in trays 202, 204, and 206 and leaf bag 230 is positioned in an open position over support bar 30′ and on platform 26. In one embodiment, tray 206 is detachable from frame 12 for use alone in a garden or other confined area.

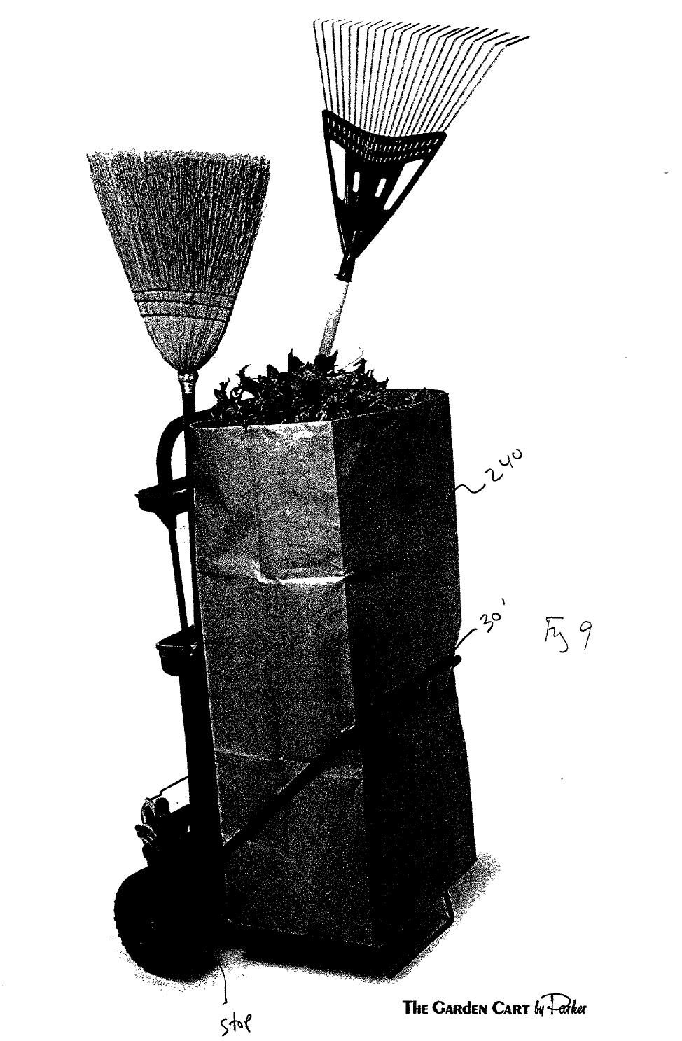

In FIG. 8, support bar 30′ is folded and locked with respect to frame 12′ by spring clip 104 and cart 200 is used as a hand truck. In FIG. 8, hook or clips 52′ and 50′ are more clearly shown for retaining one side of the open end of a leaf bag or garbage bag (or utility bag 36, FIG. 3) against frame 12′. In FIG. 9, leaf bag 240 is secured in place via angled support bar 30′ and the hooks are not used.

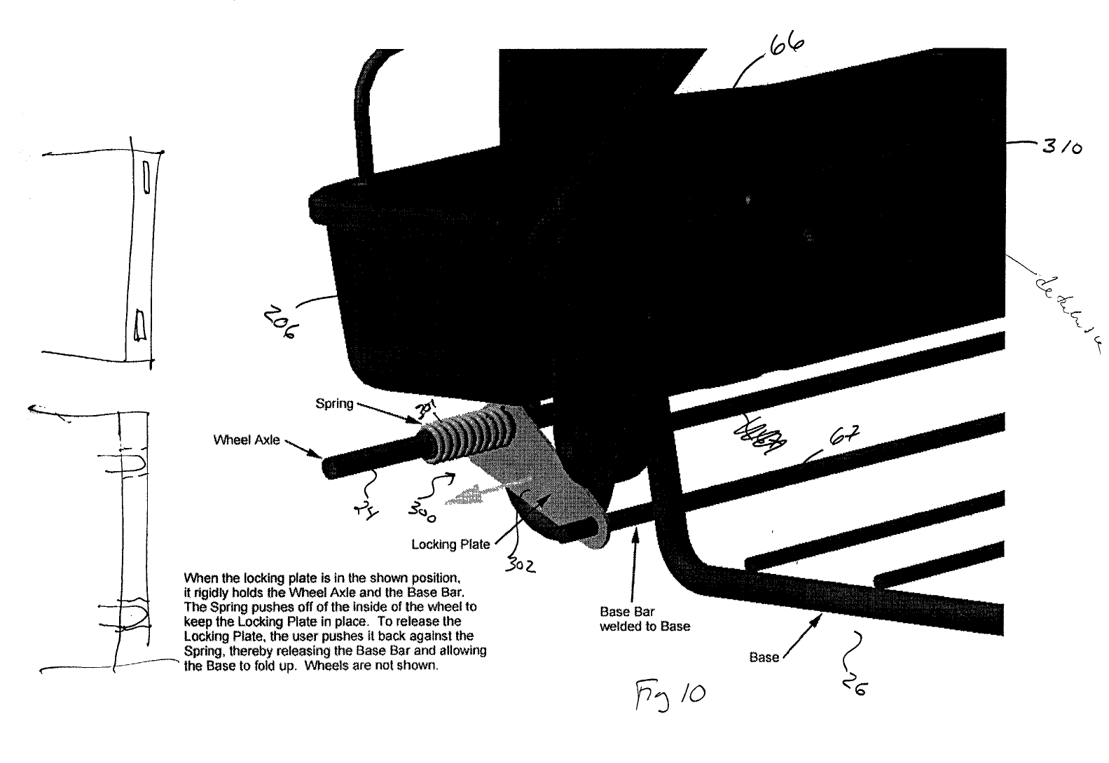

As delineated above, in the preferred embodiment, platform 26, FIG. 10 is foldable up adjacent the frame but lockable in its downward unfolded position by locking mechanism 300 which includes plate 302 extending between wheel axle 24 and horizontal support member 67. The current garden cart uses only one locking mechanism 300. Other designs may use two (one in each side of the frame). Thus, there may be two such locking mechanisms, one on each side of the frame. When locking plate 302 is in the position shown, it rigidly holds wheel axle 24 and base bar 67. Spring 301 pushes off the inside of the wheel (not shown) to keep locking plate 302 in place. To release locking plate 302, the user pushes it back against spring 301 thereby releasing base bar 67 and allowing support platform 26 to fold upwardly.

Also shown in FIG. 10, lip 310 of bottom tray 206 is supported on horizontal bar 66 which renders bottom tray 20 removable from the cart.

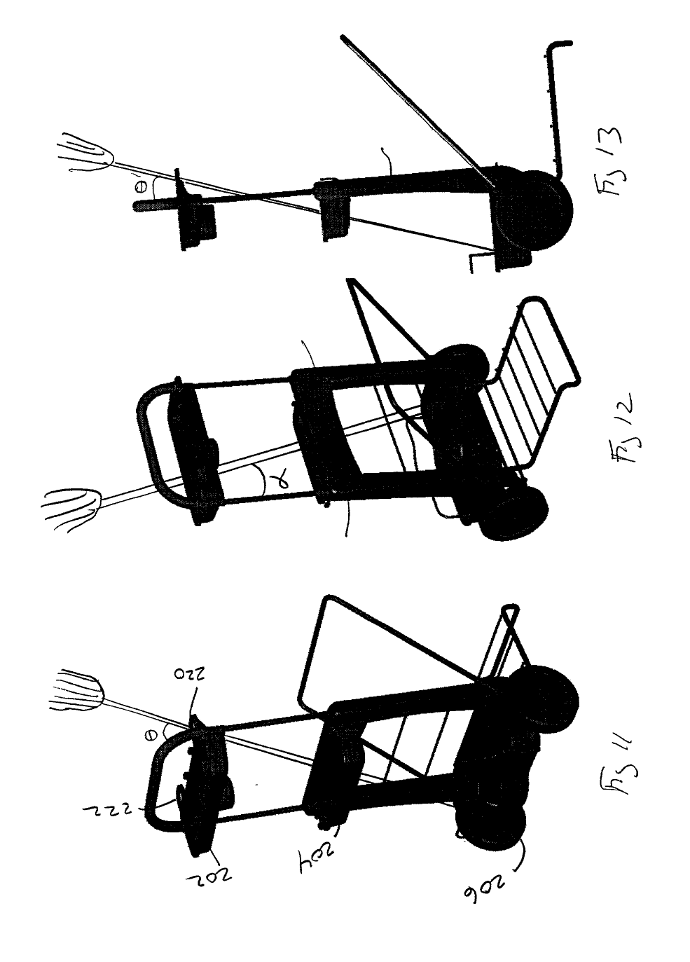

As shown in FIGS. 11-13, forward implement holders 220 and 222 of handle tray 202 are positioned to the extreme left and right of tray 202 but forward of the handle. Moreover, as shown in FIG. 6, orifices 208 and 210 in tray 204 are centrally located with respect to the frame. The reason for this configuration is that now when the handle of a broom, rake, or shovel is placed down through one of the implement holders of tray 202 and through the orifice of tray 204, it will be angled away from the user (angle θ, FIGS. 11 and 13) and also angled to the right or left (angle α, FIG. 12) to therefore avoid interfering with the user's operation of the cart and the user's visibility.

In the embodiments shown in FIGS. 1-13, the angled support bar of the utility cart extends from the lower end of the cart upwards out over the support platform which forms a portion of the hand truck configuration. The result is a more aesthetically appealing utility cart which is easier to use and which can be readily manufactured in the two versions shown: the combined hand truck, bag caddy and removable utility bag type cart shown in FIGS. 1-5 and the combined tool caddy, hand truck, and bag dolly type cart shown in FIGS. 6-9. The result is a more universal utility cart which combines the features of a utility bag, a hand truck, and a bag caddy, in a single cart or the features of a tool caddy, a hand truck and a bag dolly in a single utility cart. The same primary components are used in both embodiments to reduce manufacturing costs. In both embodiments, the design is simple and yet aesthetically pleasing and inexpensive to manufacture. The utility cart allows the consumer to both cart around items in a utility bag and also to transport larger items such as boxes. In the other embodiment, the user can transport gardening tools and equipment to the garden and also to transport leaf or garbage bags and also larger items such as large sacks of fertilizer and the like.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

Other embodiments will occur to those skilled in the art and are within the following claims:

What is claimed is:

1. A utility cart comprising:
a frame with an upper end and a lower end;
a handle extending upwardly from the upper end of the frame;
at least a pair of wheels attached to the lower end of the frame;
a platform extending outwardly from the lower end of the frame; and
an angled support bar extending from a position proximate the lower end of the frame and terminating at a position spaced from the upper end of the frame out over the platform.

2. The utility cart of claim 1 in which the frame includes a pair of spaced vertical supports.

3. The utility cart of claim 2 in which the frame includes a plurality of spaced horizontal supports extending between the pair of spaced vertical supports.

4. The utility cart of claim 1 in which the handle includes a U-shaped bar.

5. The utility cart of claim 4 in which the handle is collapsible downward into the frame.

6. The utility cart of claim 1 in which the platform includes a U-shaped bar.

7. The utility cart of claim 6 in which a platform further includes a foot member.

8. The utility cart of claim 1 in which the platform is hinged to the frame and foldable to a position adjacent the frame.

9. The utility cart of claim 8 further including a mechanism for locking the platform in an unfolded position extending outwardly from the lower end of the frame.

10. The utility cart of claim 1 in which the angled support bar is U-shaped and includes two spaced side members and a front member interconnecting the terminal ends of the two spaced side members.

11. The utility cart of claim 10 in which the frame includes a stop member for a said side member forming an angle of between 0° and 47° between the side members and the frame.

12. The utility cart of claim 10 in which the proximal ends of the two spaced side members are hinged to the frame to allow the support bar to be folded up against the frame.

13. The utility cart of claim 12 in which the frame includes at least one locking mechanism for retaining the support bar in a position folded against the frame.

14. The utility cart of claim 1 in which the frame comprises tubular members encased in a plastic housing.

15. The utility cart of claim 1 further including at least one tray attached to a rearward portion of the frame.

16. The utility cart of claim 15 further including a handle tray on the handle with at least one forward implement holder.

17. The utility cart of claim 15 in which said at least one tray is a bridge tray with at least one implement holder.

18. The utility cart of claim 15 in which said one tray is a bottom tray with a plurality of compartments.

19. The utility cart of claim 1 further including a foldable bag which rests on the platform and retained in an open configuration by the angled support bar.

20. The utility cart of claim 19 in which the foldable bag includes eyelets and the frame member includes hooks which extend through the eyelets to releasably secure the bag with respect to the frame.

21. The utility cart of claim 19 in which the foldable bag includes a securable flap which overlaps the support bar.

22. A combined utility bag, hand truck, and bag caddy utility cart comprising:
a frame with upper and lower ends;
a handle extending from the upper end of the frame;
a platform extending outwardly from the lower end of the frame;
a support bar extending from the frame out over the platform; and
a bag supported on the bottom thereof by the platform and retained in an open configuration by the support bar.

23. The utility cart of claim 22 in which the support bar is angled and extends from a position proximate the lower end of the frame and terminates at a position spaced from the upper end of the frame out over the platform.

24. The utility cart of claim 22 in which the frame includes a pair of spaced vertical supports.

25. The utility cart of claim 24 in which the frame includes a plurality of spaced horizontal supports extending between the pair of spaced vertical supports.

26. The utility cart of claim 22 in which the handle includes a U-shaped bar.

27. The utility cart of claim 22 in which the handle is collapsible downward in to the frame.

28. The utility cart of claim 22 in which the platform includes a U-shaped bar.

29. The utility cart of claim 28 in which a platform further includes a foot member.

30. The utility cart of claim 22 in which the platform is hinged to the frame and foldable to a position adjacent the frame.

31. The utility cart of claim 30 further including a mechanism for locking the platform in an unfolded position extending outwardly from the lower end of the frame.

32. The utility cart of claim 22 in which the angled support bar is U-shaped and includes two spaced side members and a front member interconnecting the terminal ends of the two spaced side members.

33. The utility cart of claim 32 in which the frame includes a stop member for a said side member forming an angle of between 0° and 47° between the side members and the frame.

34. The utility cart of claim 32 in which the proximal ends of the two spaced side members are hinged to the frame to allow the support bar to be folded up against the frame.

35. The utility cart of claim 22 in which the frame includes at least one locking mechanism for retaining the support bar in a position folded against the frame.

36. The utility cart of claim 22 in which the frame comprises tubular members encased in a plastic housing.

37. The utility cart of claim 22 in which the bag includes eyelets and the frame member includes hooks which extend through the eyelets to secure the bag with respect to the frame.

38. The utility cart of claim 22 in which the bag includes a securable flap which overlaps the support bar.

39. A combined tool caddy, hand truck, and bag dolly utility cart comprising:
a frame with an upper end and a lower end;
a handle extending from the upper end of the frame;
a platform extending outwardly from the lower end of the frame;
a support bar extending from the frame out over the platform for supporting a bag; and
at least one tool tray attached to the frame.

40. The utility cart of claim 39 further including a plurality of trays.

41. The utility cart of claim 39 further including a handle tray on the handle with at least one forward implement holder.

42. The utility cart of claim 40 in which said at least one tray is a bridge tray with at least one implement holder.

43. The utility cart of claim 40 in which said one tray is a bottom tray with a plurality of compartments.

44. The utility cart of claim 39 in which the frame includes a pair of spaced vertical supports.

45. The utility cart of claim 44 in which the frame includes a plurality of spaced horizontal supports extending between the pair of spaced vertical supports.

46. The utility cart of claim 39 in which the handle includes a U-shaped bar.

47. The utility cart of claim 39 in which the handle is collapsible downward in to the frame.

48. The utility cart of claim 39 in which the platform includes a U-shaped bar.

49. The utility cart of claim 48 in which a platform further includes a foot member.

50. The utility cart of claim 39 in which the platform is hinged to the frame and foldable to a position adjacent the frame.

51. The utility cart of claim 50 further including a mechanism for locking the platform in an unfolded position extending outwardly from the lower end of the frame.

52. The utility cart of claim 39 in which the support bar is U-shaped and includes two spaced side members and a front member interconnecting the terminal ends of the two spaced side members.

53. The utility cart of claim 52 in which the frame includes a stop member for a said side member forming an angle of between 0° and 47° between the side members and the frame.

54. The utility cart of claim 52 in which the proximal ends of the two spaced side members are hinged to the frame to allow the support bar to be folded up against the frame.

55. The utility cart of claim 52 in which the frame includes at least one locking mechanism for retaining the support bar in a position folded against the frame.

56. The utility cart of claim 39 in which the frame comprises tubular members encased in a plastic housing.

57. A utility cart comprising:
a frame with upper and lower ends;
a handle extending upwardly from the upper end of the frame;
a platform extending outwardly from the lower end of the frame; and
an angled support bar including side members extending from a position proximate the lower end of the frame and a front member spaced from the upper end of the frame out over the platform,
the frame including at least one stop member for a said side member, the support bar forming an angle between 0° and 47° between the side members of the support bar and the frame, and a locking mechanism for retaining the support bar in a position folded against the frame.
